(19) United States
(12) Patent Application Publication
(10) Pub. No.: US 2025/0342848 A1
(43) Pub. Date: Nov. 6, 2025

(54) VOICE MIXING CONVERSION SYSTEM AND VOICE MIXING CONVERSION METHOD

(71) Applicant: Industrial Technology Research Institute, Hsinchu (TW)

(72) Inventors: Hsiao-Wei Liu, Hsinchu County (TW); Liang-Hsuan Tai, Hsinchu City (TW); Yi-Hsiung Chen, Hsinchu County (TW); Cheng Sun, New Taipei City (TW)

(73) Assignee: Industrial Technology Research Institute, Hsinchu (TW)

(21) Appl. No.: 18/769,406

(22) Filed: Jul. 11, 2024

(30) Foreign Application Priority Data
May 6, 2024 (TW) 113116746

(51) Int. Cl. G10L 21/02; G10L 25/30

(52) U.S. Cl. CPC G10L 21/02; G10L 25/30

(57) ABSTRACT

A voice mixing conversion method includes: performing a noise reduction processing on the initial generated speech based on a noise threshold to generate a post-noise reduction speech; calculating a first quality score and a second quality score, wherein in response to a number of the initial generated speech being 1, the first quality score is calculated based on the initial generated speech, and the second quality score is calculated based on the post-noise reduction speech; and determining whether the first quality score is greater than the second quality score, wherein in response to the first quality score being greater than the second quality score, the initial generated speech is output, otherwise the post-noise reduction speech is output.

### CROSS-REFERENCE TO RELATED APPLICATION

This application claims the priority benefit of Taiwan application serial no. 113116746, filed on May 6, 2024. The entirety of the above-mentioned patent application is hereby incorporated by reference herein and made a part of specification.

### TECHNICAL FIELD

The disclosure relates to a conversion technique, and in particular to a voice mixing conversion system and a voice mixing conversion method.

### BACKGROUND

AI techniques have been significantly introduced into speech synthesis techniques, reducing the cost of speech synthesis and expanding the flexible application of speech (singing/speaking). However, there are still difficulties that need to be overcome in current techniques. For example, it is difficult to obtain speech training data, and the cost of speech annotation is higher.

Furthermore, current speech quality evaluation of speech synthesis commonly includes Mel-Cepstral distortion (MCD), Mean Opinion Score (MOS), and Perceptual Evaluation of Speech Quality (PESQ). However, if a single method is used to evaluate the speech quality of synthesized speech, the best quality synthesized speech may not always be obtained, and the evaluation time is also longer.

Therefore, how to improve the quality of speech synthesis and reduce the evaluation time of speech (mixing) synthesis is an urgent issue that needs to be solved.

### SUMMARY

The disclosure provides a voice mixing conversion system, including: a voice input unit, a memory, and a processor. The voice input unit is configured to receive voice data and an unknown test audio file; the memory is configured to store a pre-training model; the processor is coupled to the memory and the voice input unit and configured to perform the following steps: performing a data pre-processing on the voice data, including: removing a plurality of silent segments from the voice data, merging and normalizing the voice data with the plurality of silent segments removed, and then performing a frequency sampling rate conversion on the merged and normalized voice data to generate a training audio file; reading the pre-training model, inputting the training audio file into the pre-training model, and training the pre-training model to a trained model using the training audio file and a verifying audio file; performing a speech denoising and separation on the unknown test audio file, and performing an inference via the trained model using a denoised and separated audio file to be processed and the verifying audio file to obtain an initial generated speech; performing a noise reduction processing on the initial generated speech based on a noise threshold to generate a post-noise reduction speech; calculating a first quality score and a second quality score, wherein in response to a number of the initial generated speech being 1, the first quality score is calculated based on the initial generated speech, and the second quality score is calculated based on the post-noise reduction speech, or in response to the number of the initial generated speech being greater than 1, the initial generated speeches are mixed to generate a pre-noise reduction mixed audio file, the first quality score is calculated based on the pre-noise reduction mixed audio file, the post-noise reduction speeches are mixed to generate a post-noise reduction mixed audio file, and the second quality score is calculated based on the post-noise reduction mixed audio file; and determining whether the first quality score is greater than the second quality score, and outputting the initial generated speech or the pre-noise reduction mixed audio file in a case that the first quality score is greater than the second quality score, otherwise outputting the post-noise reduction speech or the post-noise reduction mixed audio file.

The disclosure also provides a voice mixing conversion method, including: receiving voice data via a voice input unit; performing a data pre-processing on the voice data, including: removing a plurality of silent segments from the voice data, merging and normalizing the voice data with the plurality of silent segments removed, and then performing a frequency sampling rate conversion on the merged and normalized voice data to generate a training audio file; inputting the training audio file into a pre-training model, and training the pre-training model to a trained model using the training audio file and a verifying audio file; inputting an unknown test audio file via the voice input unit, performing a speech denoising and separation on the unknown test audio file, and performing an inference via the trained model using the denoised and separated unknown test audio file and the verifying audio file to obtain an initial generated speech; performing a noise reduction processing on the initial generated speech based on a noise threshold to generate a post-noise reduction speech; calculating a first quality score and a second quality score, wherein in response to a number of the initial generated speech being 1, the first quality score is calculated based on the initial generated speech, and the second quality score is calculated based on the post-noise reduction speech, or in response to the number of the initial generated speech being greater than 1, the initial generated speeches are mixed to generate a pre-noise reduction mixed audio file, the first quality score is calculated based on the pre-noise reduction mixed audio file, the post-noise reduction speeches are mixed to generate a post-noise reduction mixed audio file, and the second quality score is calculated based on the post-noise reduction mixed audio file; and determining whether the first quality score is greater than the second quality score, outputting the initial generated speech or the pre-noise reduction mixed audio file in a case that the first quality score is greater than the second quality score, otherwise outputting the post-noise reduction speech or the post-noise reduction mixed audio file.

Based on the above, the voice mixing conversion system and the voice mixing conversion method provided by the disclosure may improve the quality of voice generation and enhance multi-person voice mixing output.

### BRIEF DESCRIPTION OF THE DRAWINGS

FIG. 1 is a schematic diagram of a voice mixing conversion system shown according to an embodiment of the disclosure.

FIG. 2 is a schematic diagram of a voice mixing conversion method shown according to an embodiment of the disclosure.

FIG. 3A to FIG. 3B are flowcharts of a voice mixing conversion method shown according to an embodiment of the disclosure.

FIG. 4 is a flowchart shown according to step S320 of FIG. 3A.

FIG. 5 is a schematic diagram of a pre-training model/trained model in a voice mixing conversion system shown according to an embodiment of the disclosure.

FIG. 6A to FIG. 6D are schematic diagrams of a first unit to a fourth unit in a pre-training model/trained model shown according to an embodiment of the disclosure.

### DETAILED DESCRIPTION OF DISCLOSED EMBODIMENTS

A portion of the exemplary embodiments of the disclosure is described in detail hereinafter with reference to figures. In the following, the same reference numerals in different figures should be considered to represent the same or similar elements. The exemplary embodiments are a part of the disclosure, and do not disclose all possible implementation modes of the disclosure. Rather, these exemplary embodiments are merely examples of methods and systems within the scope of the patent application of the disclosure.

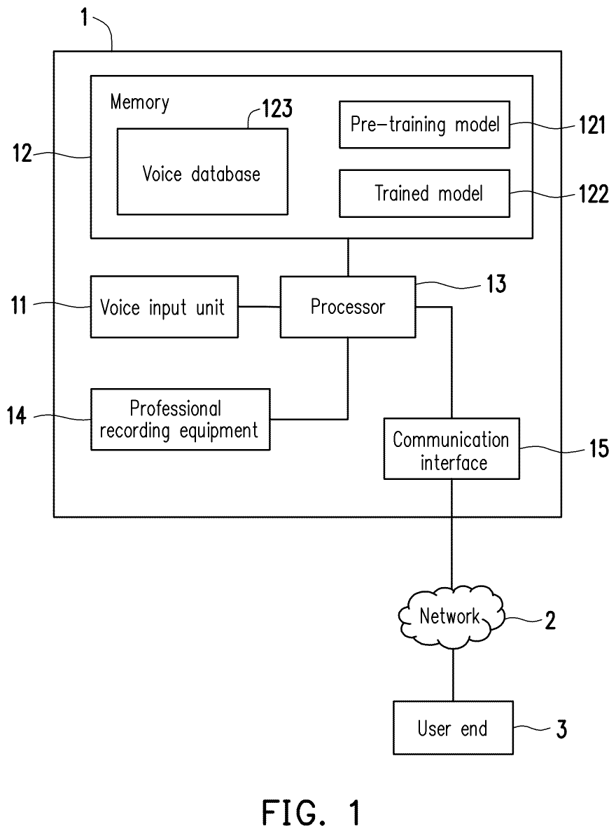

FIG. 1 is a schematic diagram of a voice mixing conversion system 1 shown according to an embodiment of the disclosure. The voice mixing conversion system 1 of the disclosure includes a voice input unit 11, a memory 12, and a processor 13. First, the various members and configuration relationships in the voice mixing conversion system 1 are introduced via FIG. 1. Detailed functions are disclosed in conjunction with subsequent embodiments.

The voice input unit 11 is configured to receive voice data and an unknown test audio file. Practically speaking, the voice input unit 11 may be, for example, a wired microphone, a wireless microphone, or other voice input units having a voice input function, and the disclosure is not limited thereto.

The memory 12 is configured to store a pre-training model 121 and a trained model 122, wherein the pre-training model 121 becomes the trained model 122 after being trained. The memory 12 also includes a voice database 123. The voice database 123 is configured to store voice data and a verifying audio file. Practically speaking, the memory 12 is, for example, a static random-access memory (SRAM), a dynamic random-access memory (DRAM), or other memories, and the disclosure is not limited thereto.

The processor 13 is coupled to the voice input unit 11 and the memory 12. In practice, the processor 13 may be, for example, a central processing unit (CPU), an application processor (AP), or other programmable general-purpose or special-purpose microprocessors, digital signal processors (DSP), or other similar devices, integrated circuits, and a combination thereof, and the disclosure is not limited thereto.

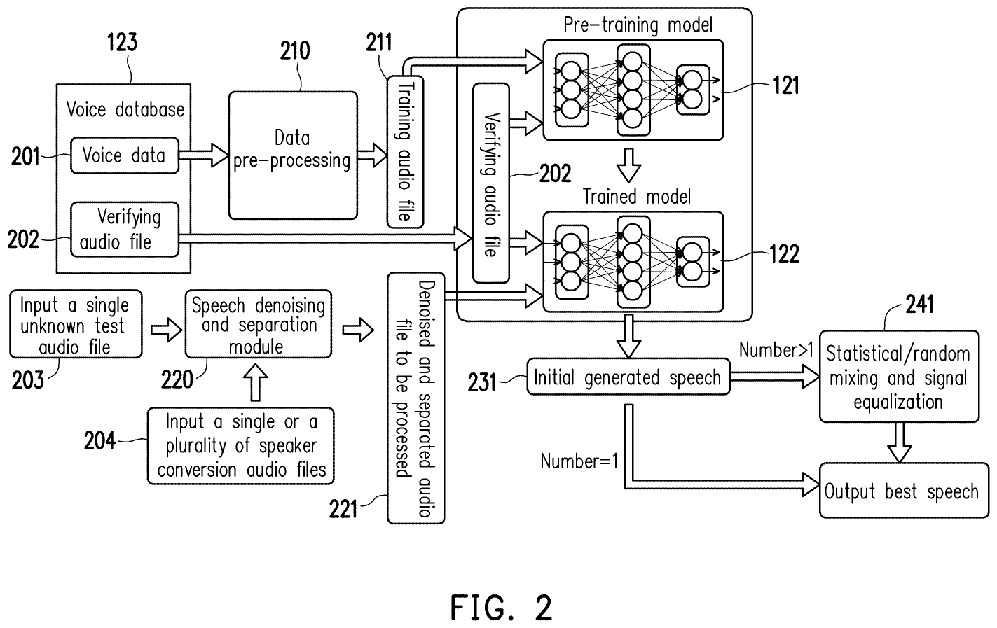

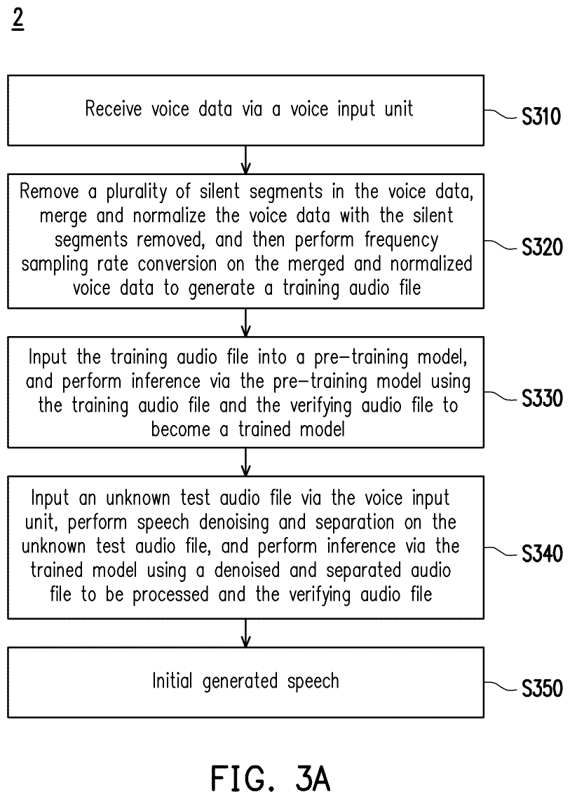

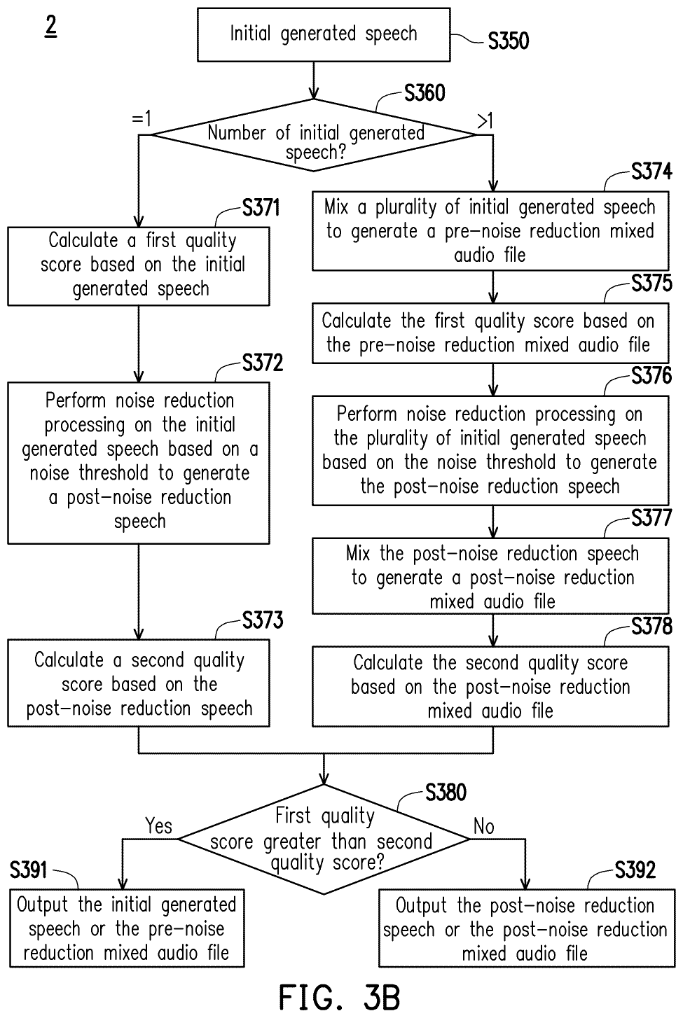

The processor 13 is configured to execute a voice mixing conversion method 2. FIG. 2 is a schematic diagram of the voice mixing conversion method 2 shown according to an embodiment of the disclosure. FIG. 3A to FIG. 3B are flowcharts of the voice mixing conversion method 2 shown according to an embodiment of the disclosure. The process of the voice mixing conversion method 2 of FIG. 2 and FIG. 3A to FIG. 3B may be executed by the processor 13 of the voice mixing conversion system 1 of FIG. 1. Next, please refer to FIG. 1, FIG. 2, and FIG. 3A to FIG. 3B at the same time, and the voice mixing conversion system 1 and the voice mixing conversion method 2 are described.

First, in step S310, the processor 13 receives voice data 201 via the voice input unit 11 and stores the voice data 201 in the voice database 123.

In an embodiment of the disclosure, the voice mixing conversion system 1 further includes a professional recording equipment 14 coupled to the memory 12 and the processor 13 and configured to capture a plurality of voice signals of a plurality of different speakers. The processor 13 forms a plurality of voice data 201 according to a plurality of voice signals of a plurality of different speakers, and stores the voice data 201 in the voice database 123 of the memory 12.

Next, in step S320, the processor 13 reads the voice data 201 and performs a data pre-processing 210 on the voice data 201 to generate a training audio file 211 for training the pre-training model 121.

Specifically, the processor 13 removes a plurality of silent segments from the voice data 201, merges and normalizes the voice data with the plurality of silent segments removed, and then performs frequency sampling rate conversion on the voice data 201 to generate the training audio file 211.

In step S330, the processor 13 inputs the training audio file 211 into the pre-training model 121, and trains the pre-training model 121 to become the trained model 122 using the training audio file 211 and a verifying audio file 202 stored in the voice database 123. After the pre-training model 121 is trained to become the trained model 122, the processor 13 may perform inference on a single unknown test audio file 203 input by the user via the trained model 122.

In step S340, the processor 13 inputs the unknown test audio file 203 via the voice input unit 11, and speech denoising and separation is first performed on the unknown test audio file 203 input by the user and a single or a plurality of speaker conversion audio files 204 using a speech denoising and separation module 220 to generate a denoised and separated audio file 221 to be processed.

Next, after the processor 13 performs inference via the trained model 122 using the denoised and separated unknown test audio file 203 and the one or plurality of verifying sound files 202 stored in the voice database 123, in step S350, one or a plurality of initial generated speeches 231 are obtained.

In particular, the verifying audio file 202 is selected by the user from the voice database 123, and one or a plurality may be selected. The processor 13 performs inference via the trained model 122 using the denoised and separated audio file 221 to be processed and the verifying audio file 202 according to at least one verifying audio file 202 selected by the user to obtain at least one initial generated speech 231 in sequence. Therefore, the number of the initial generated speech 231 is the same as the number of the verifying audio file 202.

In step S360, the processor 13 performs post-processing according to the number of the initial generated speech 231.

If the processor 13 infers one initial generated speech 231 via the trained model 122, the processor 13 proceeds to step S371 to calculate a first quality score Q_{i,org} based on the initial generated speech 231. Next, the processor 13 then proceeds to step S372 to perform noise reduction processing on the initial generated speech 231 based on a noise threshold to generate a post-noise reduction speech, and in step S373, a second quality score Q_{i,denoise} is calculated based on the post-noise reduction speech. Lastly, in step S380, the processor 13 determines whether the first quality score Q_{i,org} is greater than the second quality score Q_{i,denoise}. If the first quality score Q_{i,org} is greater than the second quality score Q_{i,denoise}, in step S391, the initial generated speech is output, that is, the initial generated speech is used as an output best speech maxQ. Otherwise, in step S392, the post-noise reduction speech is output, that is, the post-noise reduction speech is used as the output best speech maxQ. In other words, the processor 13 selects the higher of the first quality score Q_{i,org} and the second quality score Q_{i,denoise} as the best speech maxQ.

If the number of the initial generated speech 231 inferred by the processor 13 via the trained model 122 is greater than 1, the processor 13 performs a statistical/random mixing and signal equalization process 241. Specifically, in the statistical mixing and signal equalization process, the user arbitrarily defines the mixing ratio. If the number of the initial generated speech is equal to three, the total of the mixing ratios of the three is 100%, such as 40%, 30%, and 30% respectively; and in the random mixing and signal equalization process, the user does not define the mixing ratio, and the system mixes randomly. In step S374, the plurality of initial generated speeches 231 are mixed to generate a pre-noise reduction audio file. In step S375, the processor 13 calculates the first quality score Q_{i,org} based on the pre-noise reduction audio file. Next, the processor 13 further performs step S376 to perform noise reduction processing on the plurality of initial generated speeches 231 based on the noise threshold to generate a post-noise reduction speech. In step S377, the processor 13 mixes the post-noise reduction speech to generate a post-noise reduction mixed audio file. And in step S378, the processor 13 calculates the second quality score Q_{i,denoise} based on the post-noise reduction mixed audio file. Lastly, in step S380, the processor 13 determines whether the first quality score Q_{i,org} is greater than the second quality score Q_{i,denoise}. If the first quality score Q_{i,org} is greater than the second quality score Q_{i,denoise}, in step S391, the pre-noise reduction mixed audio file is output, otherwise, in step S392, the post-noise reduction mixed audio file is output, that is, the best speech maxQ is output.

The first quality score Q_{i,org} of steps S371 and S375 and the second quality score Q_{i,denoise} of steps S377 and S378 are both generated by mixing and calculating a subjective score and an objective score. The subjective scoring adopted in the technique of the disclosure is related to Perceptual Evaluation of Speech Quality (PESQ), and the objective scoring is related to Mel-Cepstral distortion (MCD).

$$First quality score {Q}_{i , org} = \frac{{pesq}_{i}}{4.5} + \frac{10}{{mcd}_{i}} ; \\ Second quality score {Q}_{i , denoise} = \frac{{pesq}_{i}}{4.5} + \frac{10}{{mcd}_{i}} ; \\ Best speech max Q = max \{ {Q}_{i , org} , {Q}_{i , denoise} \} .$$

When the processor 13 mixes the plurality of initial generated speeches 231 in step S374, and when the processor 13 mixes the post-noise reduction speeches in step S377, the user may give different proportions of weights to each of the plurality of initial generated speeches 231 and each of the post-noise reduction speeches, and the processor 13 weights each of the plurality of initial generated speeches 231 and each of the post-noise reduction speeches with different proportions of weights for mixing.

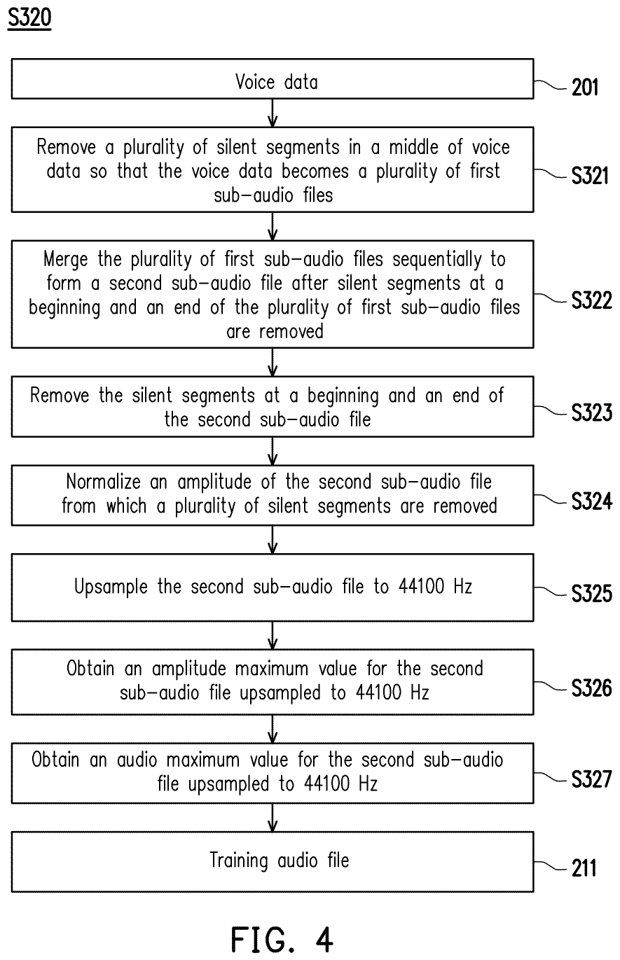

Next, the detailed steps in step S320 are further described, in which the processor 13 removes a plurality of silent segments in the voice data 201 and merges and normalizes the voice data with the plurality of silent segments removed, then frequency sampling rate conversion is performed on the voice data 201 to generate the training audio file 211. FIG. 4 is a flowchart shown according to step S320 of FIG. 3A. Please refer to FIG. 4.

In step S321, the processor 13 removes a plurality of silent segments in the middle of the voice data 201 so that the voice data 201 becomes a plurality of first sub-audio files. In step S322, after the silent segments at the beginning and the end of the plurality of first sub-audio files are removed, the processor 13 sequentially merges the plurality of first sub-audio files to form a second sub-audio file. In step S323, the processor 13 removes the silent segments at the beginning and the end of the second sub-audio file. For example, it is assumed that the total length of the voice data 201 is 10 seconds, wherein the 5th second to the 6th second are silent segments, then the processor 13 removes the silent segments (the 5th second to the 6th second) of the voice data 201, acquires the 0th second to the 5th second and the 6th second to the 10th second of the voice data 201, and merges the two pieces of voice data from the 0th second to the 5th second and the 6th second to the 10th second. The length of the combined voice data is 9 seconds in total.

In step S324, the processor 13 normalizes the amplitude of the second sub-audio file with the plurality of silent segments removed. In step S325, the processor 13 upsamples the second sub-audio file to 44100 Hz. In step S326, the processor 13 obtains the maximum amplitude value of the second sub-audio file upsampled to 44100 Hz. In step S327, the processor 13 obtains the maximum audio value of the second sub-audio file upsampled to 44100 Hz. Lastly, in step S328, the processor 13 generates the training audio file 211 for training the pre-training model 121.

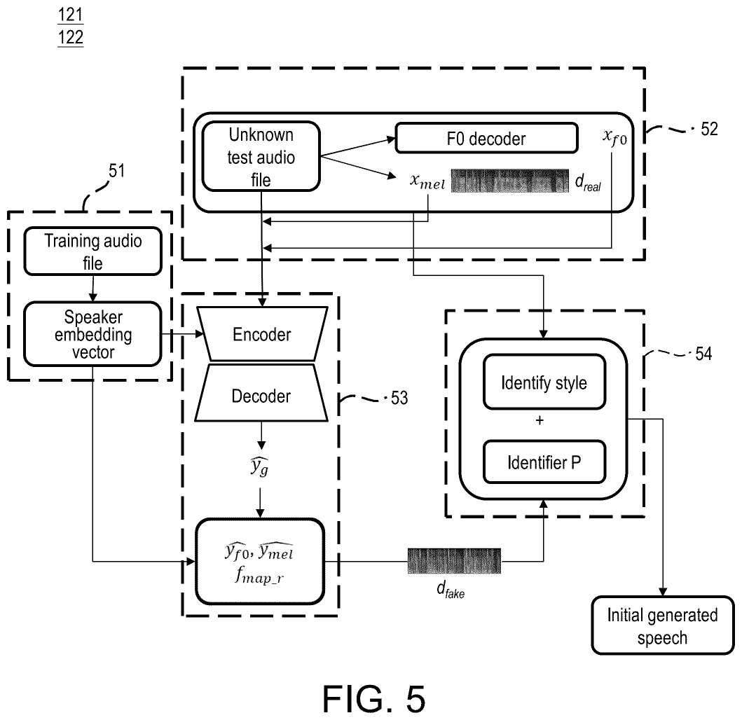

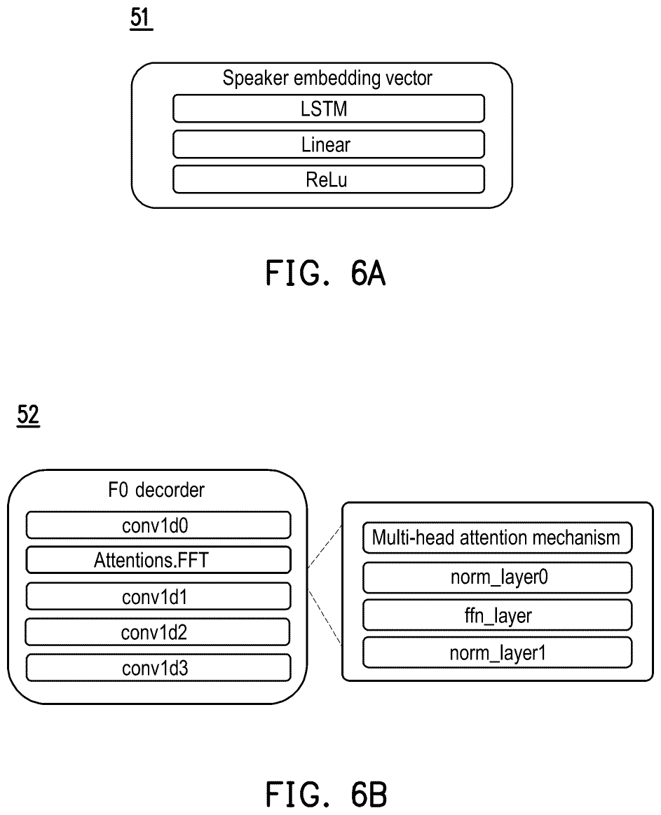

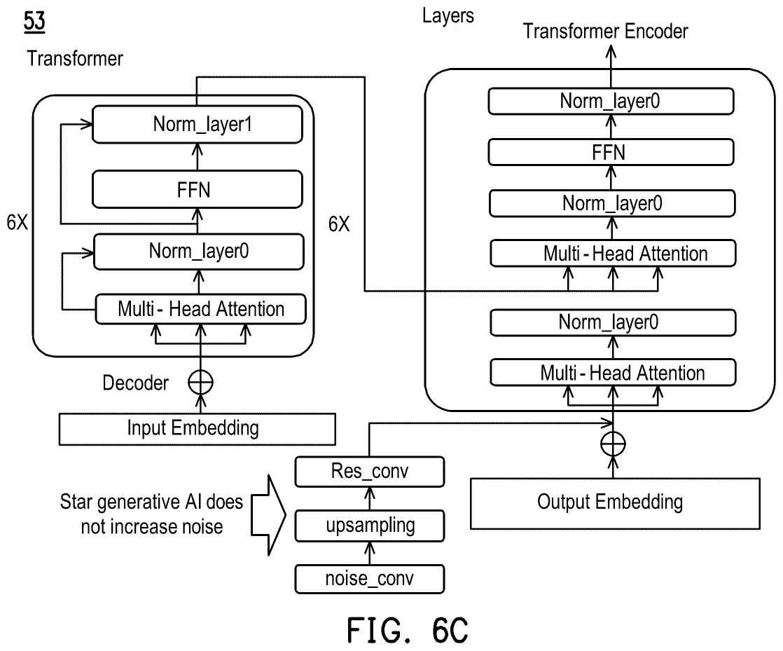

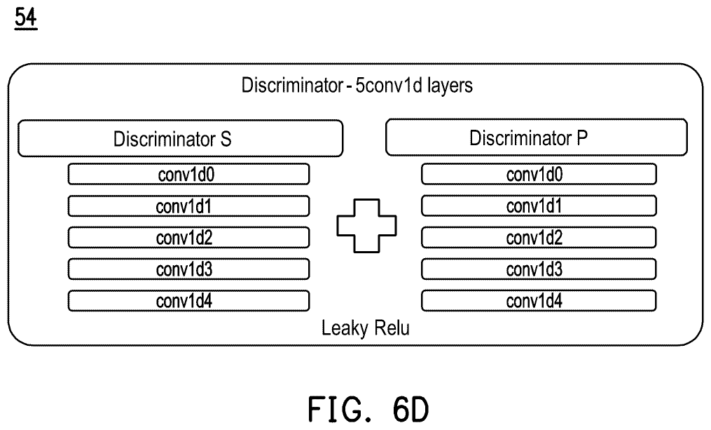

FIG. 5 is a schematic diagram of the pre-training model 121/the trained model 122 in a voice mixing conversion system 1 shown according to an embodiment of the disclosure. The pre-training model 121/the trained model 122 include a first unit 51, a second unit 52, a third unit 53, and a fourth unit 54. FIG. 6A to FIG. 6D are schematic diagrams of the first unit 51 to the fourth unit 54 in the pre-training model 121/the trained model 122 shown according to an embodiment of the disclosure. Please refer to FIG. 5 and FIG. 6A to FIG. 6D at the same time.

The processor 13 reads the voice data 201 of a plurality of speakers, and performs the data pre-processing 210 on the plurality of voice data 201 to generate the training audio file 211 corresponding to the plurality of speakers, and the training audio file 211 is configured as the audio file for training the pre-training model 121. In the first unit 51, the training audio file 211 is read to perform speaker embedding vector of the mark of each speaker and automatic learning of neural network features for speech pre-processing.

The processor 13 inputs the unknown test audio file 203 via the voice input unit 11, and performs speech denoising and separation on the unknown test audio file 203 using the speech denoising and separation module 220 to generate the denoised and separated audio file 221 to be processed. The second unit 52 of the trained model 122 extracts a corresponding F0 feature xⱼ₀ for the denoised and separated audio file 221 to be processed.

The speaker embedding vector read by the first unit 51 and the F0 feature xⱼ₀ of real data dᵣₑₐₗ obtained by the second unit 52 are sent to the third unit 53. The third unit 53 is one generator equipped with a multi-head attention mechanism. The generator generates fake data d_{fake} and sends the fake data d_{fake} to the fourth unit 54.

In addition, the generator is also equipped with a multiple combination loss function L. The multiple combination loss function L is the sum of five functions: function L_{feature}, function L_{gen}, function Lₘₑₗ, function Lⱼ₀, and function Lₖₗ, that is

$$L = {L}_{feature} + {L}_{gen} + {L}_{mel} + {L}_{f 0} + {L}_{kl} ;$$

The function L_{feature} is a function calculating the sum of the style average absolute value error amount, and the formula is L_{feature}=Σmean|f_{map_r}, f_{map_g}|.

The function L_{gen} is a function calculating the average error amount between generated audio [symbol] and 1, and the formula is L_{gen}=Σmean( \sqrt{(1− [symbol] )²}).

The function Lₘₑₗ is a function calculating the 1 norm error amount of the Mel spectrum, and the formula is Lₘₑₗ=||xₘₑₗ, [symbol] ||.

The function Lⱼ₀ is a function calculating the mean square error of the F0 feature xⱼ₀ between the generated audio and the real audio dᵣₑₐₗ, and the formula is L_{f0}=MSE( [symbol] , x_{f0}).

The function Lₖₗ is a function calculating the KL similarity error amount (Kullback-Leibler Divergence) between generated audio and real audio, and the formula is

$${L}_{kl} = \sum p ( x ) log ( \frac{p ( x )}{Q ( x )} ) .$$

The fourth unit 54 has a plurality of identifiers P configured to identify the unknown test audio file (i.e., the real data dᵣₑₐₗ) of the first unit 51 and the fake data d_{fake} generated by the third unit 53 to generate the initial generated speech. The pre-training model 121/the trained model 122 obtain a plurality of feature layers via the plurality of identifiers P of the fourth unit 54.

In the voice mixing conversion system 1 and the voice mixing conversion method 2 provided by the disclosure, in addition to inputting the unknown test audio file 203 via the voice input unit 11, the voice mixing conversion system 1 may further include a communication interface 15 coupled to the processor 13 and configured to receive the unknown test audio file 203 from a client end 3 via the network 2.

The voice mixing conversion system 1 and the voice mixing conversion method 2 provided by the disclosure may allow a client end 3 to perform voice mixing conversion via a web interface. After the client end 3 uploads the unknown test audio file 203 via the network 2 using a terminal device such as a mobile device, a notebook computer, a desktop computer, or a tablet, the verifying audio file 202 may be selected from the voice database 123, including giving different proportions of weights to each of the plurality of initial generated speeches 231 and each of the post-noise reduction speeches to mix the plurality of initial generated speeches 231 and post-noise reduction speeches.

Based on the above, the voice mixing conversion system and the voice mixing conversion method provided by the disclosure may improve the quality of voice generation and enhance the multi-person voice mixing output. In terms of improving the quality of speech generation, the disclosure proposes heterogeneous integrated voice data collection (professional recording studio recordings, public data, TTS generated data) combined with audio sampling rate pre-processing and normalization, multi-head attention mechanism, and multiple loss functions to alleviate the signal issues or sound conversion issues of traditional and current speech generation quality. In terms of enhancing multi-person voice mixing output, in the disclosure, at least one person outputs speech for mixing to provide different mixing weight ratios and provide quantitative performance calculations of speech quality in order to reduce the time cost of manual subjective determination and reduce the time cost of traditional multi-person voice creation and mixing.

What is claimed is:

1. A voice mixing conversion system, comprising:
a voice input unit configured to receive voice data and an unknown test audio file;
a memory configured to store a pre-training model;
a processor coupled to the memory and the voice input unit and configured to perform the following steps:
performing a data pre-processing on the voice data, comprising:
removing a plurality of silent segments in the voice data, merging and normalizing the voice data with the silent segments removed, and then performing a frequency sampling rate conversion on the merged and normalized voice data to generate a training audio file;
reading the pre-training model, inputting the training audio file into the pre-training model, and training the pre-training model to become a trained model using the training audio file and a verifying audio file;
performing a speech denoising and separation on the unknown test audio file, and performing an inference via the trained model using a denoised and separated audio file to be processed and the verifying audio file to obtain an initial generated speech;
performing a noise reduction processing on the initial generated speech based on a noise threshold to generate a post-noise reduction speech; calculating a first quality score and a second quality score, wherein
in response to a number of the initial generated speech being 1, the first quality score is calculated based on the initial generated speech and the second quality score is calculated based on the post-noise reduction speech; or
in response to a number of the initial generated speech being greater than 1, the initial generated speeches are mixed to generate a pre-noise reduction mixed audio file and the first quality score is calculated based on the pre-noise reduction mixed audio file, and the post-noise reduction speeches are mixed to generate a post-noise reduction mixed audio file and the second quality score is calculated based on the post-noise reduction mixed audio file; and
determining whether the first quality score is greater than the second quality score, and outputting the initial generated speech or the pre-noise reduction mixed audio file in a case that the first quality score is greater than the second quality score, otherwise outputting the post-noise reduction speech or the post-noise reduction mixed audio file.

2. The voice mixing conversion system of claim 1, further comprising:
a professional recording equipment coupled to the processor and the memory and configured to capture a plurality of voice signals of different people;
wherein the processor forms the voice data according to the voice signals and stores the voice data in a voice database of the memory.

3. The voice mixing conversion system of claim 1, wherein the processor is further configured to:
remove the silent segments in a middle of the voice data so that the voice data becomes a plurality of first sub-audio files;
merge the first sub-audio files sequentially to form a second sub-audio file after the silent segments at a beginning and an end of the first sub-audio files are removed; and
remove the silent segments at a beginning and an end of the second sub-audio file.

4. The voice mixing conversion system of claim 1, wherein the processor is further configured to read a speaker embedding vector of the training audio file via the pre-training model, and train with a multi-head attention mechanism and a multiple combination loss function to generate a generated audio file.

5. The voice mixing conversion system of claim 1, wherein the processor is further configured to:
weight each of the initial generated speeches and each of the post-noise reduction speeches with different proportions of weights for mixing.

6. The voice mixing conversion system of claim 1, wherein the first quality score and the second quality score are both generated by mixing and calculating a subjective score and an objective score.

7. The voice mixing conversion system of claim 6, wherein the subjective score is related to Perceptual Evaluation of Speech Quality (PESQ), and the objective score is related to Mel-Cepstral distortion (MCD).

8. The voice mixing conversion system of claim 1, wherein the pre-training model comprises a plurality of discriminators, and a plurality of feature layers are obtained via the discriminators.

9. The voice mixing conversion system of claim 3, wherein when performing the frequency sampling rate conversion of the voice data, the processor is further configured to:
upsample the second sub-audio file to 44100 HZ.

10. The voice mixing conversion system of claim 1, further comprising:
a communication interface coupled to the processor and configured to receive the unknown test audio file via a network.

11. A voice mixing conversion method, comprising:
receiving voice data via a voice input unit;
performing a data pre-processing on the voice data, comprising:
removing a plurality of silent segments in the voice data, merging and normalizing the voice data with the silent segments removed, and then performing a frequency sampling rate conversion on the merged and normalized voice data to generate a training audio file;
inputting the training audio file into a pre-training model, and training the pre-training model to become a trained model using the training audio file and a verifying audio file;
inputting an unknown test audio file via the voice input unit, performing a speech denoising and separation on the unknown test audio file, and then performing an inference via the trained model using a denoised and separated audio file to be processed and the verifying audio file to obtain an initial generated speech;
performing a noise reduction processing on the initial generated speech based on a noise threshold to generate a post-noise reduction speech; calculating a first quality score and a second quality score, wherein
in response to a number of the initial generated speech being 1, the first quality score is calculated based on the initial generated speech and the second quality score is calculated based on the post-noise reduction speech; or
in response to the number of the initial generated speech being greater than 1, the initial generated speeches are mixed to generate a pre-noise reduction mixed audio file and the first quality score is calculated based on the pre-noise reduction mixed audio file, and the post-noise reduction speeches are mixed to generate a post-noise reduction mixed audio file and the second quality score is calculated based on the post-noise reduction mixed audio file; and
determining whether the first quality score is greater than the second quality score, and outputting the initial generated speech or the pre-noise reduction mixed audio file in a case that the first quality score is greater than the second quality score, otherwise outputting the post-noise reduction speech or the post-noise reduction mixed audio file.

12. The voice mixing conversion method of claim 11, further comprising:
capturing a plurality of voice signals of different people via a professional recording equipment to form the voice data and storing the voice data in a voice database.

13. The voice mixing conversion method of claim 11, wherein the step of removing the silent segments in the voice data and merging the voice data with the silent segments removed comprises:
removing the silent segments in a middle of the voice data so that the voice data becomes a plurality of first sub-audio files;
merging the first sub-audio files sequentially to form a second sub-audio file after the silent segments at a beginning and an end of the first sub-audio files are removed; and
removing the silent segments at a beginning and an end of the second sub-audio file.

14. The voice mixing conversion method of claim 11, wherein the step of generating the trained model by performing the inference on the training audio file and the verifying audio file via the pre-training model comprises:
reading a speaker embedding vector of the training audio file via the pre-training model, and training with a multi-head attention mechanism and a multiple combination loss function to generate a generated audio file.

15. The voice mixing conversion method of claim 11, wherein the steps of mixing the initial generated speeches and mixing the post-noise reduction speeches both comprise:
weighting each of the initial generated speeches and each of the post-noise reduction speeches with different proportions of weights for mixing.

16. The voice mixing conversion method of claim 11, wherein the first quality score and the second quality score are both generated by mixing and calculating a subjective score and an objective score.

17. The voice mixing conversion method of claim 16, wherein the subjective score is related to Perceptual Evaluation of Speech Quality (PESQ), and the objective score is related to Mel-Cepstral distortion (MCD).

18. The voice mixing conversion method of claim 11, wherein the pre-training model comprises a plurality of discriminators, and a plurality of feature layers are obtained via the discriminators.

19. The voice mixing conversion method of claim 13, wherein the step of performing the frequency sampling rate conversion of the voice data comprises:
upsampling the second sub-audio file to 44100 HZ.

20. The voice mixing conversion method of claim 11, further comprising:
receiving the unknown test audio file via a network.
